(19) United States
(12) Patent Application Publication
(10) Pub. No.: US 2003/0039802 A1
(43) Pub. Date: Feb. 27, 2003

(54) Package

(76) Inventor: Robert Matzinger, Halmstad (SE)

Correspondence Address: OSTROLENK FABER GERB & SOFFEN, 1180 AVENUE OF THE AMERICAS, NEW YORK, NY, 100368403

(21) Appl. No.: 10/181,096

(22) PCT Filed: Jan. 9, 2001
(86) PCT No.: PCT/SE01/00028

(30) Foreign Application Priority Data
Jan. 11, 2000 (SE) 0000066-1

(51) Int. Cl. B32B 3/04

(52) U.S. Cl. 428/121; 428/132; 428/136

(57) ABSTRACT

The invention relates to a package comprising a lid-equipped container, such as a cup, a tray etc., made of plastic, cardboard, plastic-coated cardboard or the like, especially for ready-made food dishes to be heated in microwave owens or by addition of boiling water, said container (1) having an inner flange (4) which surrounds its opening (3) against which the lid (2) is arranged to rest sealingly, so as to form the package. The lid (2) has at least two opposite flaps (5, 6) which can be bent over and around said rim flange (4) towards the exterior wall side of the container (1) and at their free outer portions (16, 17) can be secured to the lower portion (9) of the container (1) in order to form an interspace (10) acting as a heat insulator in consequence of the rim flange (4) keeping the flaps (5, 6) out of tight contact with the container (1), said flaps (5, 6) also serving as handles (11, 12) permitting handling of the package also when it is in the hot state.

The present invention relates to a package comprising a lid-equipped container, such as cups, trays etc. made of plastic, plastic-coated cardboard or the like, especially for ready-made food dishes to be heated in microwave owens or by addition of boiling water. The container has a rim flange which surrounds its opening and against which the lid is arranged to rest sealingly so as to form said package.

Today, there do exist in the market a plurality of different package types consisting of a tray having a lid sealed on mount of it. Those packages are in the first place intended to contain ready-made food. They can be heated, preferably in microwave owens. The problem connected to this type of package is that, after the heating up, the package is so hot that it cannot be handled manually. Instead one has to use a pot-holder or the like in connection with the serving or handling. Alternatively a spoon is used to transfer directly to a plate the content which has been heated in the microwave owen. However, in those cases where the intention is to eat directly from the package, there arise significant problems as far as the handling of the container concerns because, after the heating, it is very hot.

The object of the present invention is to provide a package of the type above mentioned and, more specifically, a lid for such a package at which the drawbacks described above have been eliminated. The features characterizing the invention are set out in the claims enclosed.

Thanks to the invention there has now been provided a package including a combined lid and handle. The package can be constituted by a tray having a lid and it can be manufactured by plastic, cardboard, plast-coated cardboard or the like. Its primary field of use is for ready-made dishes to be heated in microwave owens or simply by addition of boiling water. However, a condition is that the tray, being part of the package, has around its opening a flange projecting outward and permitting sealing by use of a plastic coated cardboard lid.

According to one embodiment of the invention the cardboard lid is provided with flaps at two opposite sides. According to another embodiment all four sides have flaps and the lid is sealed to the container after having been filled with the relevant product. The flaps are then bent down and sealed against the external wall of the container at the lower portion thereof. Thanks to the flange or flanges projecting outward around the opening of the container the upper portion of the flaps cannot come into close contact with the container so that a space is defined which functions both as a heat insulator and as a handle. In this way it becomes possible conveniently to catch the hot container without burning oneself. The flaps can be given different forms and in one case first be bent along the flange downward at an angle of 90°, whereupon they are brought in angles into contact with the lower portion of the container. This solution offers an increased protection against heat and, in addition thereto, the handle will exhibit a plane surface which is advantageous during these exceeding handling steps because it becomes simpler to line up the completed containers in connection with automatized filling and sealing thereof.

The invention will now be described in greater detail with reference to a few preferred embodiments and to the annexed drawings.

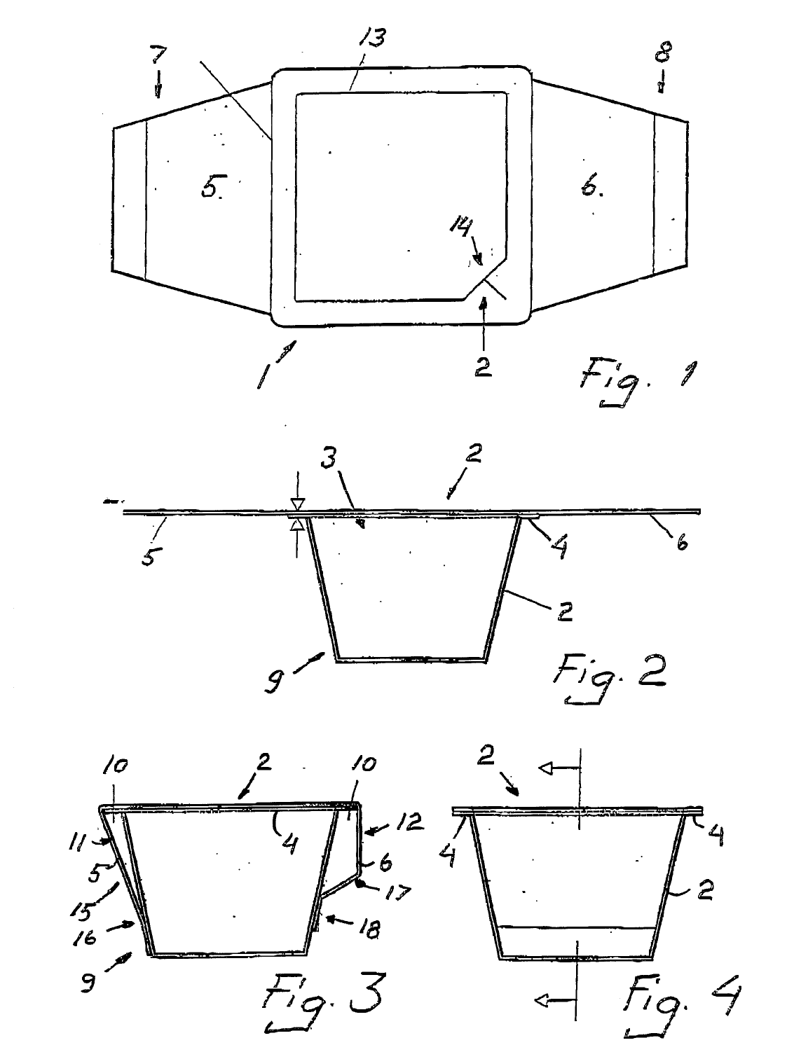

FIG. 1 is a top view showing a container provided with a lid according to the invention. The flaps of the lid are in a position where folding down against the outer surface of the container and sealing not yet has taken place.

FIG. 2 is a cross-sectional, lateral view of the container shown in FIG. 1.

FIG. 3 is a cross-sectional view of the container according to FIGS. 1 and 2. The flaps of the lid have been bent down and brought into contact with the lower portion of the container. The two flaps have mutually different configurations.

FIG. 4 shows another lateral view of the container according to FIGS. 1-3.

FIG. 1 shows a preferred embodiment illustrating a package consisting of a container 1 and a lid 2. The container 1 can be in the shape of a cup, a tray or the like and it may be manufactured in plastic, cardboard, plastic-coated cardboard or the like. The package is especially intended to be used for ready-made food dishes to be heated either in microwave owens or simply by addition to boiling water. The container 1 has a rim flange 4 extending around its opening 3 and against which the lid 2 can be sealed. The lid 2 consists preferably of cardboard which can be coated with a plastic substance permitting convenient heat-sealing.

In the example shown the lid 2 is provided with two opposite flaps 5 and 6. The end portions 7 and 8 of these flaps 5 and 6 can be secured to the lower portion 9 of the container 1 for the purpose of defining an open space 10 offering heat insulation. As appears from the drawing, edge flange 4 prevents the flaps 5 and 6 to come into close contact with the outer surface of container 1. They do also form handles 11 and 12 making it possible-conveniently to catch the hot package without any burning risk.

FIG. 1 does also illustrate that said lid 2 can be provided with a pre-cut breaking-up line 13, which extends around the opening of the package and facilitates the opening operation. Also, said breaking-up line 13 can terminate in a special rupture indication 14 at one of the corners of the container. This makes it possible to open the lid after having pressed down the corner section, for example with a thumb, in order to get access to one edge of the lid 2, so that said lid 2 can then easily be removed.

According to an alternate embodiment, not shown in the drawing, the lid 2 can be provided with flaps at all four sides. When the filling operation is completed the lid 2 is sealed to container. Next the flaps are bent down and secured to the lower portion 9 of the container which is then ready for delivery.

As appears from FIG. 3 flaps 5 and 6 may exhibit different configurations. The flap 5, to the left in the drawing, is constituted by a straight, obliquely downwards directed flap section 15 extending to the lower portion of the container 1, the outer free end 16 of which is somewhat bent in order to conform to and become sealed to the lower container portion 9.

According to the embodiment shown to the right in FIG. 3 the flap 6 has been bent downwards at right angles around the edge flange 4 to form a flap section 17, the free end portion 18 of which at a predetermined level relatively the outer wall of container 1 has been bent in towards the lower portion 9 of container 1 in order to conform to and become sealed thereto.

In those cases when flap 6 has first been bent downwards at an angle of 90° and later inwards towards the container 1 as has been described above, the heat protection will be further improved. There is also created a smooth surface facilitating the succeeding handling because it becomes simpler to line up the completed packages after or in connection with automatic handling and filling operations.

1. A package comprising a lid-equipped container, such as a cup, a tray etc., made of plastic, cardboard, plastic-coated cardboard or the like, especially for ready-made food dishes to be heated in microwave ovens or by addition of boiling water, said container (1) having a rim flange (4) which surrounds its opening (3) and against which the lid (2) is arranged to rest sealingly so as to form said package, characterized in that said lid (2) has at least two oposite flaps (5,6) which can be bent over and around said rim flange (4) towards the exterior wall side of the container (1) and at their free outer portion (16,17) can be secured to the lower portion (9) of the container (1) in order to form an interspace (10) acting as a heat insulator in consequence of the rim flange (4) keeping the flaps (5,6) out of right contact with the container (1), said flaps (5,6) also serving as handles (11,12) permitting handling of the package also when it is in a hot state.

2. A package according to claim 1, characterized in that at least one (5) of the flaps is formed like a straight, obliquely towards the lower portion (9) of the container (1) extending flap unit (15) the outer, free portion (16) of which is slightly bent to provide a sealing connection to the lower portion (9) of container (1).

3. A package according to claim 1, characterized in that at lease one (6) of the flaps is bent downwards at right angles to the plane of the rim flange (4), to form a flap unit (17) which, after a predetermined distance along the external wall side of the container (1), is directed inwards toward the lower portion of the container (1) to provide a sealing connection therewith.

4. A package according to claim 1, characterized in that said lid (2) is equipped with two flaps at opposite sides thereof and adapted to be secured to the rim flange (4) of the container (1) and to said lower portion (9) of the external wall side of the container, following a relevant filling operation.
